(19) United States
(12) Patent Application Publication
(10) Pub. No.: US 2026/0121453 A1
(43) Pub. Date: Apr. 30, 2026

(54) AUXILIARY POWER FOR MICROROBOT FACTORY

(71) Applicant: L'OREAL, Paris (FR)

(72) Inventor: Rafael Feliciano, New Providence, NJ (US)

(73) Assignee: L'OREAL, Paris (FR)

(21) Appl. No.: 18/931,458

(22) Filed: Oct. 30, 2024

(51) Int. Cl. H02J 50/10; B60L 13/04; H02J 50/00; H02J 50/40; H02J 50/90

(52) U.S. Cl. CPC H02J 50/10; B60L 13/04; H02J 50/005; H02J 50/40; H02J 50/90

(57) ABSTRACT

A system for wirelessly powering a micro-robot platform is disclosed herein. The system is comprised of a micro-robot platform and one or more wireless charging zones, wherein the micro-robot platform is configured to levitate over the one or more wireless charging zones. The micro-robot platform is further comprised of a micro-robot, a plurality of printed circuit board (PCB) layers arranged in a “stack-up” structure, a magnetic levitation (MAGLEV) stack, a wireless power stack, and a microcontroller unit (MCU). The micro-robot platform may be charged wirelessly using inductive charging, wherein magnetically coupled inductive loop coils transfer power from the wireless charging zone to the micro-robot platform. The transferred power is then directed to the various PCB layers using a demultiplexer for power storage, MAGLEV, and peripheral processes according to the MCU's programming.

### SUMMARY

Disclosed herein is a system for wirelessly powering a micro-robot platform, including a micro-robot platform and one or more wireless charging zones, where the micro-robot platform may be configured to levitate over the one or more wireless charging zones. The micro-robot platform may include a micro-robot having a plurality of magnets, a plurality of printed circuit board (PCB) layers arranged in a “stack-up” structure, a magnetic levitation (MAGLEV) stack, a wireless power stack, and a microcontroller unit (MCU). The MAGLEV stack may include a micro-robot diver circuit configured to levitate the platform. The wireless power stack may include a power storage device, a first inductive loop coil configured to charge the power storage device, and a wireless power driver circuit. The one or more wireless charging zones may include a second inductive loop coil, which may be configured to transfer power to the first inductive loop coil.

In some embodiments, the MCU includes a demultiplexer configured to receive a direct current and provide power to the MAGLEV stack and the wireless power stack.

In some embodiments, the demultiplexer alternates between charging the power storage device for a first duration of time and powering the MAGLEV stack for a second duration of time.

In some embodiments, the micro-robot platform of the described system further includes a peripheral stack. In such an embodiment, the demultiplexer is configured to receive a direct current and provide power and processing to the peripheral stack.

In some embodiments, the first inductive loop coil is a PCB coil.

In some embodiments, the first inductive coil is electrically coupled to the power storage device and secured to the micro-robot platform with an adhesive.

In some embodiments, the described system further includes a work surface, which includes a flexible PCB substrate, a motor base located under the flexible PCB substrate, and one or more linear actuators coupled to the motor base. In this embodiment, the one or more linear actuators are configured to adjust the flexible PCB substrate. As such, the flexible PCB substrate is configured to adjust a pitch, a yaw, a roll, or a combination thereof of the micro-robot platform. The micro-robot platform may be configured to levitate over the work surface.

In some embodiments, the one or more wireless charging zones are disposed within the work surface.

In some embodiments, the one or more wireless charging zones are disposed a distance away from the work surface.

In some embodiments, the power storage device is a battery.

In some embodiments, the power storage device is a supercapacitor.

In some embodiments, the first inductive loop coil and the second inductive loop coil are magnetically coupled by a Qi interface standard.

In another aspect, disclosed herein is a method for providing wireless power to a levitating micro-robot platform, including magnetically coupling a first inductive loop coil with a second inductive loop coil, securing the first inductive loop coil to a micro-robot platform such that the first inductive loop coil is electrically coupled with a power storage device, positioning the micro-robot platform above the second inductive loop coil, generating a magnetic field between the first inductive loop coil and the second inductive loop coil such that a magnetic field generates an alternating current in the first inductive loop coil, converting the alternating current into a direct current, and charging the power storage device. According to this embodiment, the micro-robot platform is arranged in a “stack-up” structure, and the micro-robot platform is configured to levitate above the second inductive loop coil.

In some embodiments, the method further includes receiving, at a demultiplexer, the direct current, and providing power to a MAGLEV stack and a wireless power stack. The demultiplexer may alternate between charging the power storage device for a first duration of time and powering the MAGLEV stack for a second duration of time.

In some embodiments, the demultiplexer is configured to receive a direct current and provide power and processing for a peripheral stack.

In some embodiments, the first inductive coil is electrically coupled to the power storage device and secured to the micro-robot platform with an adhesive.

In some embodiments, the power storage device is a battery.

In some embodiments, the power storage device is a supercapacitor.

In some embodiments, the first inductive loop coil and the second inductive loop coil are magnetically coupled by a Qi interface standard.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

FIGS. 1A-1D are example systems for wirelessly powering a micro-robot platform, in accordance with the present technology;

FIGS. 2A-2D are example micro-robots, in accordance with the present technology;

FIG. 3 is a signal processing schematic, in accordance with the present technology;

FIG. 4 is a timing diagram, in accordance with the present technology; and

FIG. 5 is a method for using a system to provide wireless power to a levitating micro-robot platform, in accordance with the present technology.

FIGS. 6A-6D are example work surfaces, in accordance with the present technology.

The foregoing aspects and many of the attendant advantages of this invention will become more readily appreciated as the same become better understood by reference to the following detailed description, when taken in conjunction with the accompanying drawings.

### DETAILED DESCRIPTION

Disclosed herein are systems, devices, and methods for wirelessly powering a micro-robot platform including a micro-robot platform and a one or more wireless charging zones. In some embodiments, the micro-robot platform includes a micro-robot, a plurality of printed circuit board (PCB) layers arranged in a stack-up structure, a magnetic levitation (MAGLEV) stack, a wireless power stack, and a peripherals stack, where the wireless power stack is configured to store and provide power to each of the stacks. In some embodiments, the one or more wireless charging zones is configured to provide power to the wireless power stack of the micro-robot platform. In some embodiments, the micro-robot platform is configured to levitate over a work surface comprised of a flexible PCB substrate, wherein the one or more wireless charging zones is disposed within the work surface.

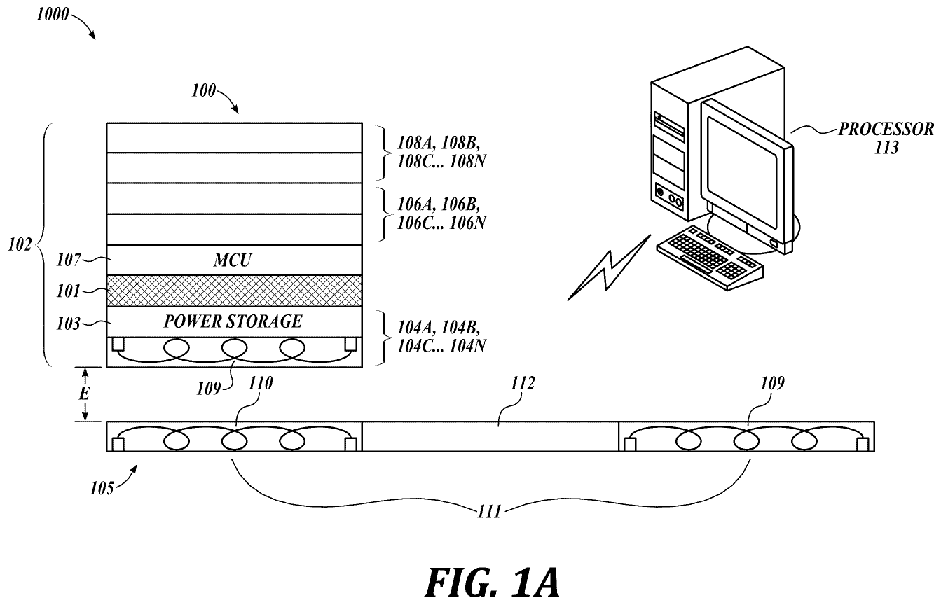

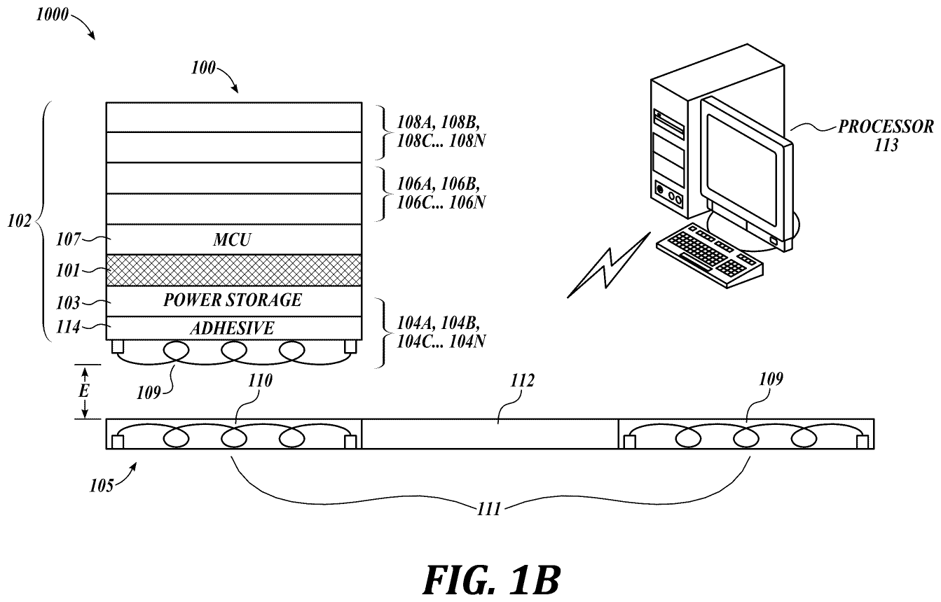

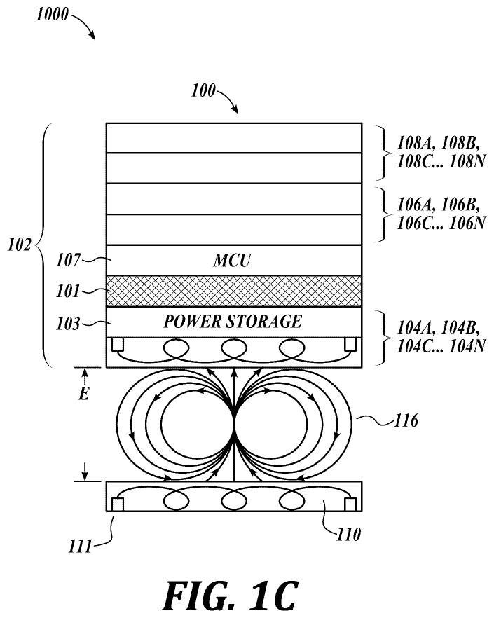

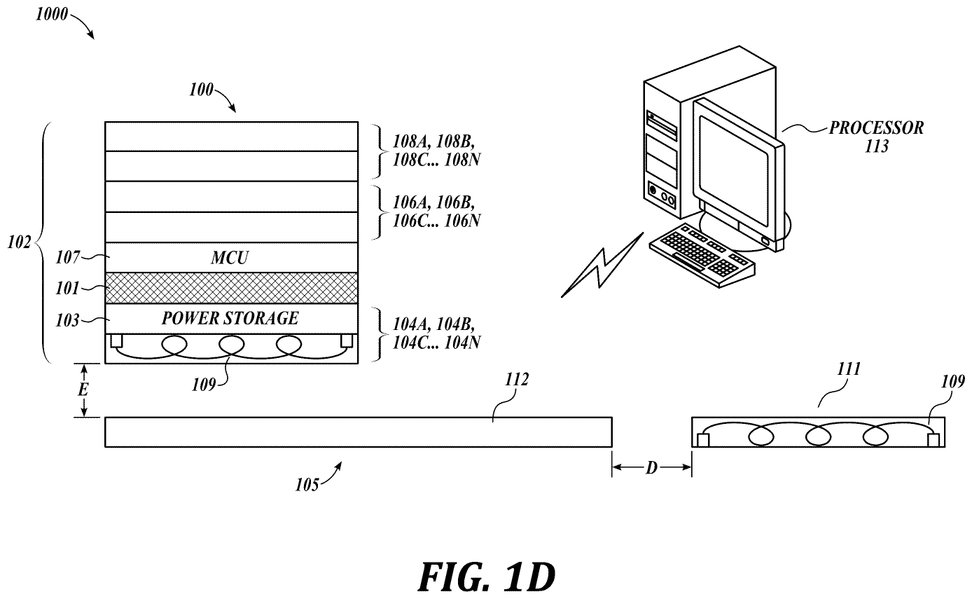

FIGS. 1A-1B are example systems for wirelessly powering a micro-robot platform, in accordance with the present technology. In some embodiments, system 1000 includes a micro-robot platform 100 and a work surface 105. In some embodiments, the work surface 105 includes one or more wireless charging zones 111 and one or more non-charging zones 112. In operation, the micro-robot platform 100 levitates above the work surface 105.

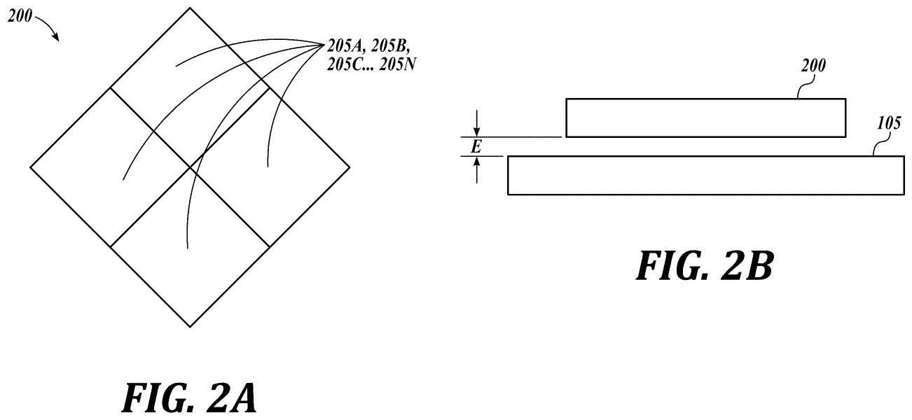

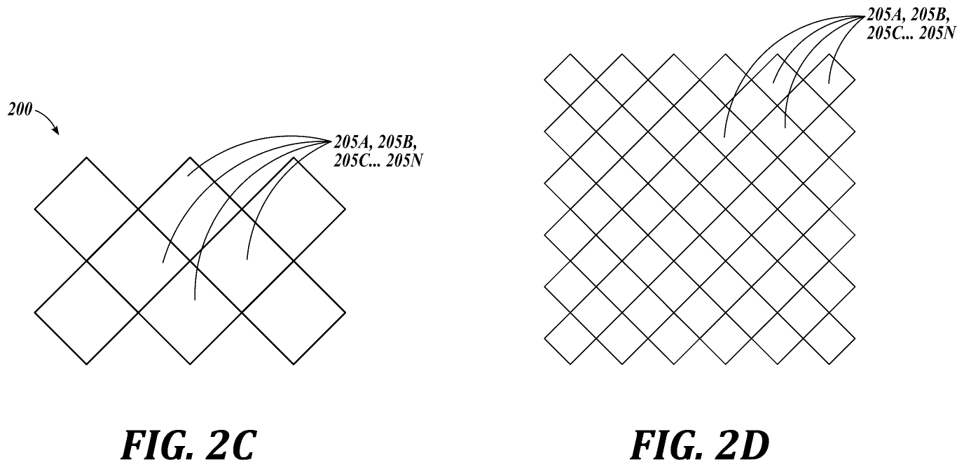

FIG. 1A shows the example system 1000 including the micro-robot platform 100 and one or more wireless charging zones 111. In some embodiments, as described herein, the micro-robot platform further includes a micro-robot 101, having a plurality of magnets, as shown in detail in FIGS. 2A-2D. In some embodiments, the micro-robot platform 100 is further includes a plurality of PCB layers 102 arranged in a “stack-up” structure. As used herein, a “stack-up” structure refers to embodiments, where the plurality of PCB layers 102 are physically stacked on top of each other such that each PCB layer 102 is physically coupled with each adjacent layer. It should be understood that the location of any individual PCB layer 102 in relation to another as depicted is provided merely as an example or illustration and should not be construed as preferred or advantageous over other embodiments. Within this “stack-up” structure are a number of different PCB layers divided into subgroups based upon their function, including a wireless power stack 104A, 104B, 104C . . . 104N; and a magnetic levitation (MAGLEV) stack 106A, 106B, 106C . . . 106N. In some embodiments, there is also a peripherals stack 108A, 108B, 108C . . . 108N, wherein additional PCB layers 102 with physically and electrically coupled micro-robot structures (not pictured) may be added to the micro-robot platform 100 to afford the micro-robot platform 100 additional functionality. In some embodiments, power and processing for each PCB layer is provided at least in part by a microcontroller unit (MCU) 107.

In some embodiments, the wireless power stack 104A, 104B, 104C . . . 104N is comprised of a power storage device 103, a first inductive loop coil 109, and a wireless power driver circuit. In some embodiments, the first inductive loop coil 109 is physically coupled with the micro-robot platform 100 such that it is a part of the same stack-up structure. In some embodiments, the components of the wireless power stack 104A, 104B, 104C . . . 104N are disposed on PCB layers 102 and electrically coupled with each other such that the first inductive loop coil 109 is configured to charge the power storage device 103. The wireless power stack 104A, 104B, 104C . . . 104N and its included components are electrically coupled with the MCU 107 by way of the wireless power driver circuit. In some embodiments, the first inductive loop coil 109 is a PCB coil, where the first inductive loop coil 109 is created directly in the PCB layer 102, forming the requisite coils from the copper traces of the PCB layer 102. As will be discussed herein, in some embodiments, the first inductive loop coil is magnetically coupled to a second inductive loop coil 110, such that the second inductive loop coil is configured to transfer power to the first inductive loop coil, and from there on to the power storage device 103. In some embodiments, the power storage device 103 is a battery; while in other embodiments, the power storage device 103 may is a supercapacitor.

In some embodiments, power and processing for each PCB layer is provided at least in part by a microcontroller unit (MCU) 107. In some embodiments, the MCU 107 includes a demultiplexer, which may be configured to provide power and processing from the MCU 107 to each of the PCB layers 102. In some embodiments, the demultiplexer alternates the PCB layers to which the MCU provides power and processing. In some embodiments, doing so allows the wireless power stack 104A, 104B, 104C . . . 104N to deliver power throughout the micro-robot platform 100 while it is operational (e.g., moving or levitating). For example, when the micro-robot platform 100 is levitating above a wireless charging zone 111, the MCU 107 may deliver power to both the MAGLEV stack 106A, 106B, 106C . . . 106N and the peripherals stack 108A, 108B, 108C . . . 108N while also charging the power storage device 103.

In some embodiments, the operation of the micro-robot platform 100 is controlled or modified by a user with a processor 113. For example, the durations of time during which power is applied by the MCU 107 to the various PCB layers 102 and their associated components may be modified by the processor 113. In some embodiments, the processor is a computer or similar device. In other embodiments, the processor is a smartphone or similar device.

In some embodiments, the MCU 107 further includes a transceiver configured to wirelessly receive instructions from a processor 113 and transmit diagnostic information relating to the operation of the wireless power stack 104A, 104B, 104C . . . 104N; and the MAGLEV stack 106A, 106B, 106C . . . 106N. In some embodiments, the transceiver is further configured to receive instructions from a processor 113 relating to the operation and functions of the peripherals stack 108A, 108B, 108C . . . 108N and transmit information collected by one or more peripheral devices that comprise the peripherals stack 108A, 108B, 108C . . . 108N. For example, as described herein, the transceiver may receive instructions for the operation of a gripper, or the transceiver may transmit images collected by a camera. In such embodiments, the MCU 107 is configured to process and deliver instructions received from the processor 113, as well as information relating to the operation of the wireless power stack 104A, 104B, 104C . . . 104N; the MAGLEV stack 106A, 106B, 106C . . . 106N; and the peripherals stack 108A, 108B, 108C . . . 108N. In some embodiments, these instructions and collected information are delivered via a wired connection.

In some embodiments, the MAGLEV stack 106A, 106B, 106C . . . 106N includes a micro-robot driver circuit configured to levitate the micro-robot platform 100. This circuit may be electrically coupled to the MCU 107, through which it may receive power from the wireless power stack 104A, 104B, 104C . . . 104N. In such embodiments, the MAGLEV stack 106A, 106B, 106C . . . 106N may remain operational—thus maintaining the micro-robot platform's 100 levitating state—while other PCB layers 102 also receive sufficient power to operate. In some embodiments, the micro-robot platform 100 levitates above a work surface 105 by an elevation E.

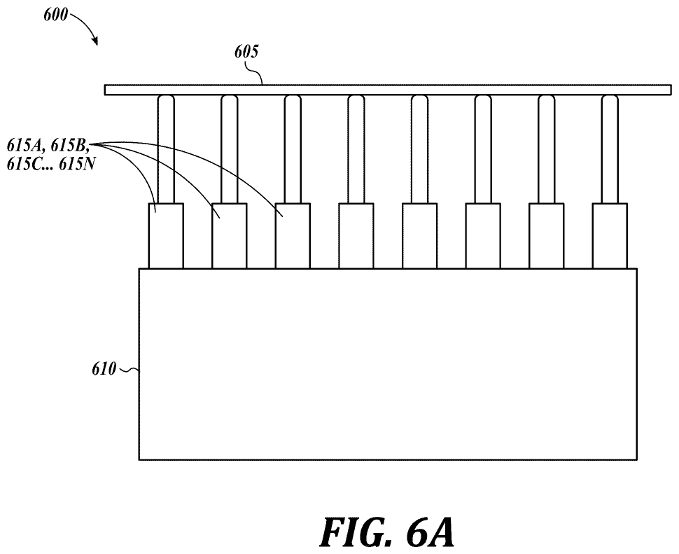

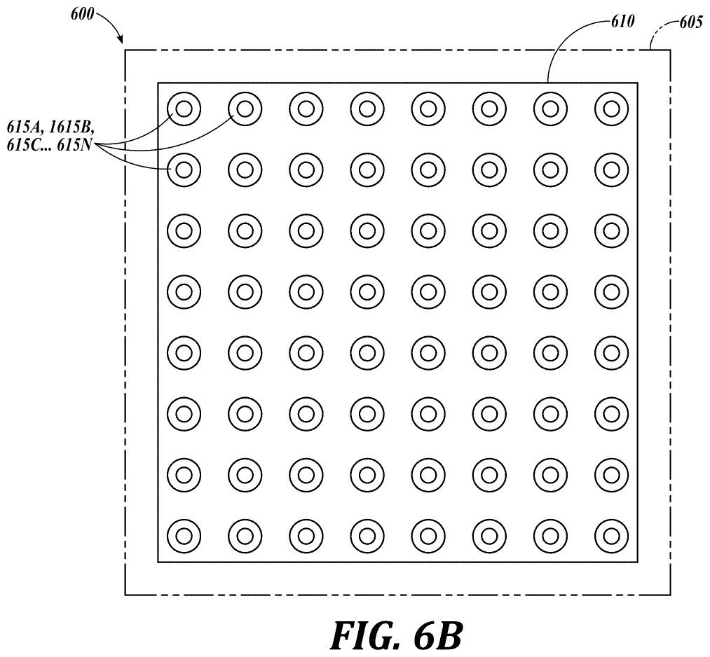

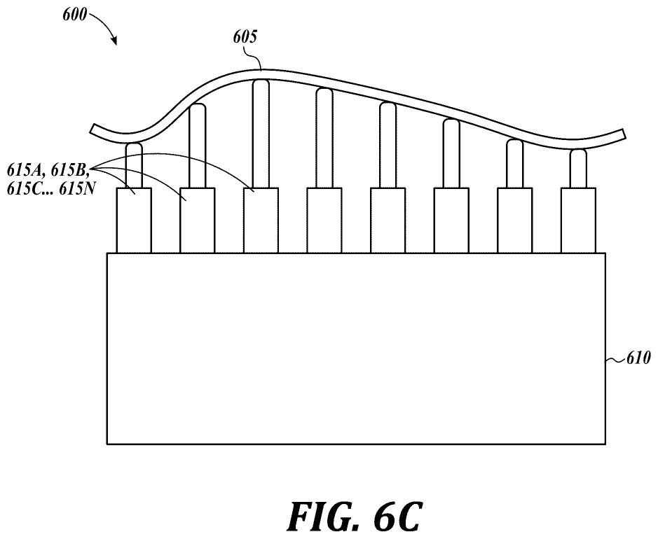

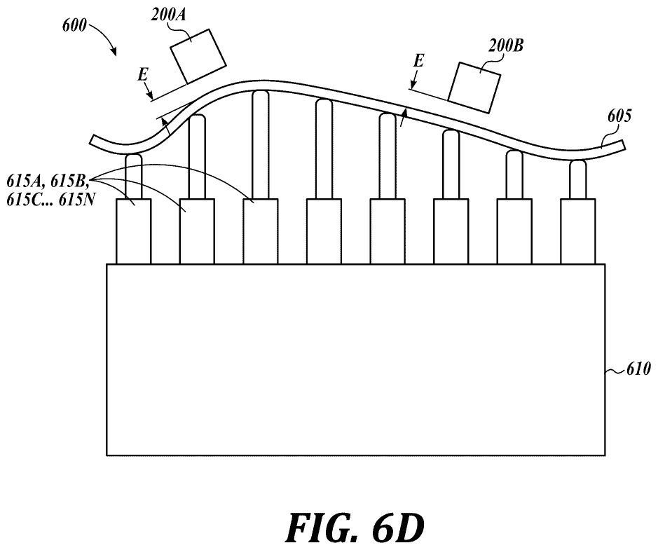

In some embodiments, the system further includes a work surface 105 comprising a flexible PCB substrate, a motor base located under the PCB substrate, and one or more linear actuators coupled to the motor base. Example motor bases and linear actuators are described in FIGS. 6A-6D. In some embodiments, the flexible PCB substrate is configured to bend and/or curve in response to the one or more linear actuators (which may be referred to herein as “adjusting” the PCB substrate). In some embodiments, the motor base is disposed below the flexible PCB substrate. The motor base is coupled to the one or more linear actuators and is configured to drive and direct the one or more linear actuators to move up and down to adjust the PCB substrate. In operation, a micro-robot platform 100 may levitate over the flexible PCB substrate. In some embodiments, the flexible PCB substrate is adjusted before the micro-robot moves over it. In other embodiments, the flexible PCB substrate may be adjusted dynamically, that is, while the one or more micro-robots are in motion. In some embodiments, the flexible PCB substrate is configured to adjust a pitch, a yaw, a roll, or a combination thereof of the micro-robot platform 100.

In some embodiments, the work surface 105 is comprised of one or more wireless charging zones 111 and one or more non-charging zones 112. In some embodiments, the one or more wireless charging zones are comprised of a second inductive loop coil 110, magnetically coupled with the first inductive loop coil 109 of the micro-robot platform 100. In some embodiments, the second inductive loop coil 110 is disposed within the work surface 105 and configured to transfer power to the first inductive loop coil 109 through wireless inductive charging. In some embodiments, the one or more non-charging zones are comprised of a flexible PCB substrate, as described in FIG. 2B.

FIG. 1B is an example system 1000 including micro-robot platform 100 and one or more wireless charging zones 111. In some embodiments, the first inductive coil 109 is secured to the micro-robot platform 100 with a layer of adhesive 114. In such an embodiment, the first inductive loop coil is not physically coupled with a PCB layer 102; however, it remains electrically coupled to the power storage device power device 103 and the MCU 107 as described above. Examples of adhesive may have an epoxy, acrylic, or silicone base.

FIGS. 1C-1D are example systems 1000 for wirelessly powering a micro-robot platform 100, in accordance with the present technology.

FIG. 1C illustrates an example system 1000 comprising a micro-robot platform 100 levitating above a work surface 105, where the micro-robot platform is disposed above a wireless charging zone 111. In some embodiments, a work surface 105 is comprised of one or more wireless charging zones 111 and one or more non-charging zones 112. In some embodiments, the one or more wireless charging zones 111 are comprised of a second inductive loop coil 110, magnetically coupled with the first inductive loop coil 109 of the micro-robot platform 100. In some embodiments, this magnetic coupling is accomplished using a Qi interface standard. In some embodiments, the second inductive loop coil 110 is disposed within the work surface 105.

In some embodiments, the micro-robot platform 100—and by extension the first inductive loop coil 109—is positioned above a wireless charging zone 111 comprised of a second inductive loop coil 110. In such an embodiment, the second inductive loop coil 110 may be configured to transfer power to the first inductive loop coil 109 through wireless inductive charging. In such an embodiment, an alternating current is passed through the second inductive loop coil 110, creating a magnetic field 116 that fluctuates based upon the amplitude of the alternating current. This fluctuating magnetic field 116 in turn creates an alternating current in first induction loop coil 109. The created alternating current is then converted into a direct current using a rectifier, after which it may be directed to the various PCBs 102 based upon the configuration of the micro-robot platform 100 and the programming of the MCU 107. In some embodiments, positioning the micro-robot platform 100 above a wireless charging zone 111 allows for near-simultaneous charging, in which the MCU 107 may be programmed to alternate which PCBs 102 receive direct current generated within the wireless power stack 104A, 104B, 104C . . . 104N. For example, the MCU 107 may direct power to the power storage device 103 for a first duration of time, then to the MAGLEV stack 106A, 106B, 106C . . . 106N for a second duration of time, followed by the peripherals stack 108A, 108B, 108C . . . 108N for a third duration of time, and so on. In such embodiments, the various PCBs 102 all receive the requisite power from the wireless power zone 111 rather than the power storage device 103. Doing so allows the various PCBs 102 to conduct their various operations while also charging the power storage device 103. In some embodiments, a number of PCBs 102 draw power from the power storage device 103 while the resulting direct current is directed by the MCU 107 to another PCB 102. For example, the MCU 107 may direct the resulting direct current toward an image sensor in the peripherals stack 108A, 108B, 108C . . . 108N to take and process and image, while the MAGLEV stack 106A, 106B, 106C . . . 106N may draw upon power from the power storage device 103 to maintain its levitated state.

FIG. 1D illustrates an example system comprising a micro-robot platform 100 levitating above a work surface 105, where the micro-robot platform is disposed above a non-charging zone 112. In some embodiments, a wireless charging zone 111 are disposed a distance D away from the work surface. In the illustrated example, the work surface 105 is comprised solely of one or more non-charging zones 112. As such, the micro-robot 100 may conduct operations when positioned above the work surface 105; however, it must do so without the benefit of near-simultaneous charging because there are no wireless charging zones 111 disposed throughout the work surface 105. Rather, the micro-robot 100 must return to the wireless charging zone 111 to recharge periodically.

FIGS. 2A-2D are example micro-robots, in accordance with the present technology.

FIG. 2A is an example micro-robot 200 including four magnets 205A, 205B, 205C . . . 205N. In some embodiments, the four magnets (also referred to herein as a plurality of magnets) 205A, 205B, 205C . . . 205N are disposed in an array with an alternating magnetization. For example, in FIG. 2A, magnets 205A (top) and 205C (bottom) may have a first magnetization and magnets 205B (left) and 205N (right) may have a second magnetization, opposite the first magnetization. In some embodiments, the plurality of magnets 205A, 205B, 205C . . . 205N are arranged like a checkerboard. In some embodiments, the plurality of magnets 205A, 205B, 205C . . . 205N are comprised of any material, such as nickel, iron, samarium, or the like. In some embodiments, the plurality of magnets 205A, 205B, 205C . . . 205N are comprised of neodymium (NdFeB). In an embodiment, the plurality of magnets comprises one or more magnetic materials. Nonlimiting examples of magnetic materials include ferromagnetic elements (e.g., cobalt, gadolinium, iron, or the like), rare earth elements, ferromagnetic metals, ferromagnetic transition metals, materials that exhibit magnetic hysteresis, or the like or combinations thereof. Further non-limiting examples of magnet materials include nickel, iron, samarium, or the like or combinations thereof.

FIG. 2B shows an example micro-robot 200 positioned on a work surface 105, which includes a flexible printed circuit board (PCB) substrate. In some embodiments, the checkerboard configuration of a plurality of magnets (such as plurality of magnets 205A, 205B, 205C . . . 205N) in conjunction with a graphite layer of the substrate 105 confines the micro-robot 200 to a specific location in (x, y, z). A magnetic potential well may be generated to localize the micro-robot 200. In some embodiments, a magnetic force is generated by four PCB current traces located inside the PCB substrate of the work surface 105. Pairs of these four traces are typically driven in quadrature, behaving very similarly to a linear stepper motor. While driving the currents in quadrature controls the relative phase between the pairs of currents and therefore the microrobot 200 in-plane position, modulating the absolute magnitude of the traces increases or decreases the out-of-plane force between the board and the robot providing about 40 to 70 μm of Z motion. FIG. 2B shows a levitating substrate system. In such embodiments, the graphite layer of the substrate 105 may be thick, such as 0.5 mm thick. In such embodiments, the micro-robot 200 may levitate off of the substrate 105 by an elevation E.

FIGS. 2C-2D show various layouts for micro-robots 200. It should be understood that any number of magnets may be included in the plurality of magnets 205A, 205B, 205C . . . 205N. In some embodiments, the plurality of magnets 205A, 205B, 205C . . . 205N are disposed in an alternating orientation, where the magnetization is alternated between adjacent magnets.

In some embodiments, the micro-robot(s) 200 are controlled by the local trace pattern and currents. That is, the micro-robot's control is area- or zone-based rather than one that moves with the micro-robot (as would be the case for conventional motorized robots). Zone control has both advantages and disadvantages for multi-agent control. The disadvantage of zone control is that two micro-robots in close proximity may not be independently controlled unless they are in different independent zones. The advantage of zone control is that large numbers of micro-robots may be controlled to execute the same motion in parallel using only a few control channels. The control zone approach generally reduces the numbers of control channels needed since the micro-robots do not need to carry extra control channels in areas which need, for example, only one degree-of-freedom for transport.

In some embodiments, the substrate or other lithographically patterned micro-circuits, enable large and complex drive systems to be made relatively easily using conventional batch fabrication. In some embodiments, the systems disclosed herein could be as large as 30 cm×30 cm, or even larger. In some embodiments, the micro-robot(s) may transition between separate substrates 105 if they are in proximity of one another.

In some embodiments, as described herein, micro-robots may be configured to “cooperate” with one another by doing different steps in a joint process process—for example, a process for applying eyelashes to a single eye or a single user having two eyes (not pictured). In some embodiments, multiple micro-robots may work together more directly.

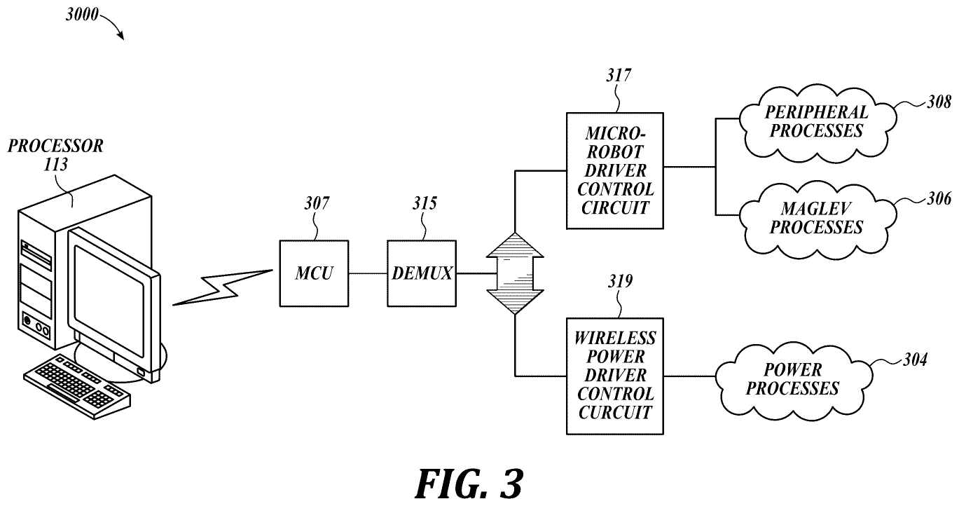

FIG. 3 is a signal processing schematic for near-simultaneous wireless charging in a micro-robot platform, in accordance with the present technology. It should be understood that components identified in this signal processing schematic 3000 are analogous to components identified in the system 1000 discussed in FIGS. 1A-1D. In some embodiments, a micro-robot platform positioned above a wireless charging zone may be configured for near-simultaneous wireless charging as described in FIG. 1D. In some embodiments, the processes of a micro-robot's various PCBs 304, 306, 308 are controlled by their respective driver control circuits 317, 319. In some embodiments, a micro-robot driver control circuit controls both the processes of the magnetic levitation (MAGLEV) stack 306 and the processes of the peripheral stack 308 as required. Examples of MAGLEV processes 306 may include levitating the micro-robot platform. Examples of peripheral processes 308 may be determined by the peripheral devices utilized in the peripherals stack, which may include gripping an eyelash or collecting and processing an image (as discussed above). In some embodiments, the wireless power driver control circuit 319 controls the processes of the wireless power stack 304. Examples of power processes 304 may include charging the power storage device.

In some embodiments, the microcontroller unit (MCU) 307 includes a demultiplexer 315 which may be configured to provide power and processing from the MCU 307 to each of the PCB layers and their associated diver control circuits 317, 319. In some embodiments, the demultiplexer alternates the PCB layers to which the MCU provides power and processing. In such embodiments, doing so allows the wireless power stack to deliver power throughout the micro-robot platform while it is operational (e.g., moving or levitating). For example, when the micro-robot platform is levitating above a wireless charging zone, the MCU 307 may deliver power to both the MAGLEV stack 306 and the peripherals stack 308 while also charging the power storage device 304. In some embodiments, a processor 313 may be configured to send instructions to a micro-robot MCU 307 that may adjust the operation of the demultiplexer 315. For example, the processor 313 may adjust the durations of time during which power is applied to a given control circuit 317, 319.

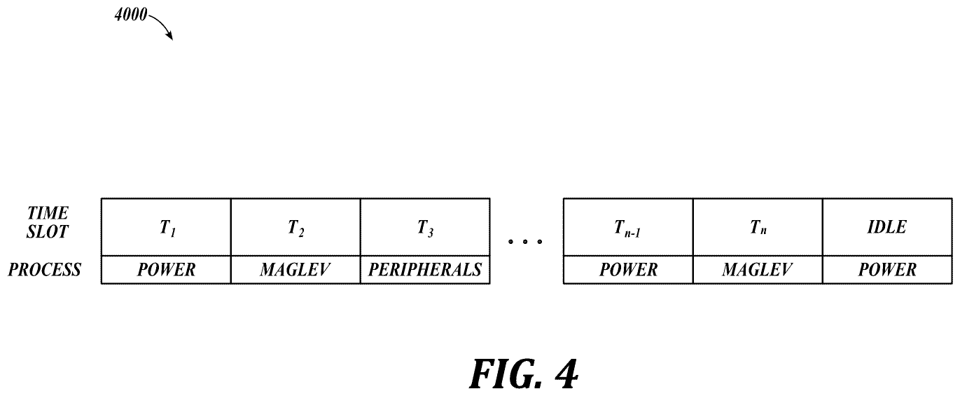

FIG. 4 is a timing diagram for near-simultaneous wireless charging, in accordance with the present technology. It should be understood that components identified in this timing diagram 400 are analogous to components identified in the system 1000 discussed in FIGS. 1A-1D. In some embodiments, a micro-robot platform positioned above a wireless charging zone may be configured for near-simultaneous wireless charging as described in FIG. 1D. In some embodiments, a micro-robot platform whose operations are controlled by a microcontroller unit (MCU) utilizes a demultiplexer to receive a direct current and provide power to the various PCBs that comprise the micro-robot platform, including the wireless power stack, the MAGLEV stack, and the peripherals stack as operations demand. For example, the MCU may direct power to the power storage device for a first duration of time, then to the MAGLEV stack for a second duration of time, followed by the peripherals stack for a third duration of time, and so on. An example of this process is illustrated in timing diagram 400, which assigns assorted processes (e.g., power processes, MAGLEV processes, etc.) to time slots T₁, T₂ . . . . Tₙ. The duration of time that a given time slot T₁, T₂ . . . . Tₙ requires may vary considerably depending upon the process. For example, charging the power storage device may require a first duration of time, while powering a peripheral device such as a light source may require a shorter second duration of time. By contrast, powering a peripheral device such as an image sensor may require power for an extended third duration of time. In some embodiments, the duration of these time slots are programmed into the MCU and adjusted as required by a processor.

In the illustrated example, a first time slot T1 is devoted to power processes. Examples of power processes 304 may include charging the power storage device. Furthermore, a second time slot T₂ is devoted to MAGLEV processes (e.g., levitating the micro-robot platform) and a third time slot T3 is dedicated to peripheral processes (e.g., gripping an eyelash). These time slots continue as determined by the MCU programming until a timeslot Tₙ, which, in this example timing diagram, is dedicated to MAGLEV processes. In some embodiments, there is a final time slot designated as an Idle state, which may be directed to times when the micro-robot platform is not in operation. In the illustrated example, power in this state is directed to wireless power processes.

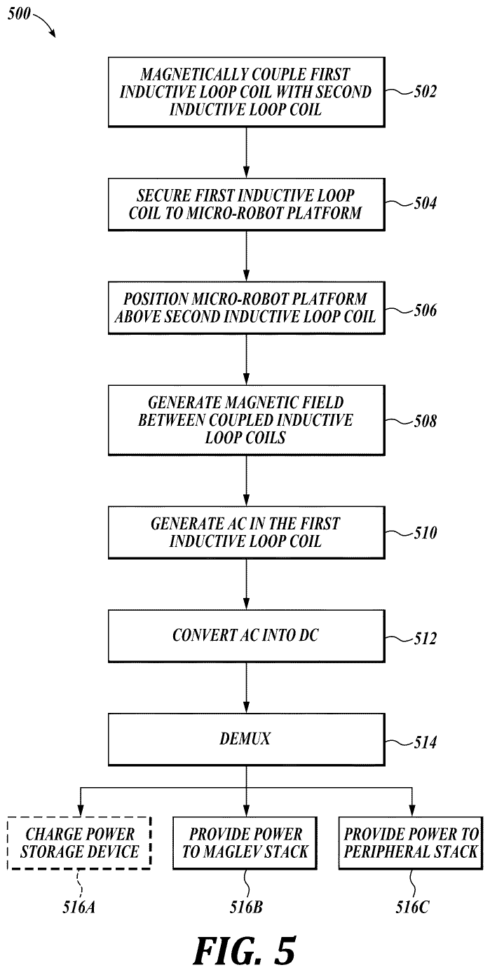

FIG. 5 is a method for using a system to provide wireless power to a levitating micro-robot platform, in accordance with the present technology. It should be understood that components identified in this method 500 are analogous to components identified in the system 1000 discussed in FIGS. 1A-1D.

In process block 502, a first inductive loop coil is magnetically coupled with a second inductive loop coil. In some embodiments, magnetically coupling these inductive loop coils allows a magnetic field to be generated between them when an alternating current is passes through the second inductive loop coil.

In process block 504, the first inductive loop coil is secured to a micro-robot platform, which is configured to levitate above a work surface. In some embodiments, the first inductive loop coil is a PCB coil, wherein the first inductive loop coil is created directly in the PCB layer, forming the requisite coils from the copper traces of the PCB layer. In some embodiments, the first inductive loop coil is secured to the micro-robot platform with an adhesive.

In process block 506, the micro-robot platform to which the first inductive loop coil is secured is positioned above the second inductive loop coil. In some embodiments, the second inductive loop coil is disposed in a wireless charging zone. In some embodiments, the wireless charging zone is disposed within the work surface, while in other embodiments, the wireless charging zone is disposed a distance away from the work surface.

In process block 508, a magnetic field is generated between the first inductive loop coil and the second inductive loop coil. This is accomplished by passing an alternating current through the second inductive loop coil.

In process block 510, an alternating current is generated in the first inductive loop coil. The magnetic field fluctuates based upon the amplitude of the alternating current, which in turn generates an alternating current in the first induction loop coil.

In process block 512, the generated alternating current is then converted into a direct current. In some embodiments, this is accomplished using a rectifier electrically coupled with the first inductive loop coil.

In process block 514, the newly-converted direct current is then directed to a microcontroller unit that includes a demultiplexer. In some embodiments, the demultiplexer is configured to receive a direct current and provide power to the various PCBs that comprise the various stacks of the micro-robot platform.

In process blocks 516A-C, the direct current is directed to the various PCBs that comprise the micro-robot platform based upon the platform's configuration and the programming of the MCU. In process block 516A, power is directed to a wireless power stack to charge a power storage device. In process block 516B, power is directed to a MAGLEV stack for a duration of time. Finally, in process block 516C, power is directed to a peripheral stack of PCBs (if present) for a duration of time. In some embodiments, the demultiplexer receives the generated direct current and direct it to these different stacks for durations of time as determined by the MCU. For example, the MCU may direct power to the power storage device for a first duration of time, then to the MAGLEV stack for a second duration of time, followed by the peripherals stack for a third duration of time, and so on. In some embodiments, this

It should be understood that method 500 should be interpreted as merely representative. In some embodiments, process blocks of this method may be performed simultaneously, sequentially, in a different order, or even omitted, without departing from the scope of this disclosure.

FIGS. 6A-6D are example work surfaces, in accordance with the present technology.

As shown in FIG. 6A, the work surface 600 may include a flexible printed circuit board (PCB) substrate 605. The system may further include a motor base 610 and one or more linear actuators 615A, 615B, 615C . . . 615N (also referred to herein as a plurality of linear actuators). In some embodiments, the flexible PCB 105 substrate is configured to bend and/or curve in response to the one or more linear actuators 615A, 615B, 615C . . . 615N, which may be referred to herein as “adjusting” the PCB substrate 605.

In some embodiments, the motor base 610 is disposed below the flexible PCB substrate 605. The motor base 610 is coupled to the one or more linear actuators 615A, 615B, 615C . . . 615N and is configured to drive and direct the one or more linear actuators 615A, 615B, 615C . . . 615N to move up and down to adjust the PCB substrate 605.

FIG. 6B is a top-down perspective of the work surface 600. The flexible PCB substrate 605 may be disposed on top of a plurality of linear actuators 615A, 615B, 615C . . . 615N. The flexible PCB substrate 605 is shown as dashed lines in FIG. 6B to better shown the position of the plurality of linear actuators 615A, 615B, 615C . . . 615N.

In some embodiments, the plurality of linear actuators 615A, 615B, 615C . . . 615N are disposed in an array. Each linear actuator of the plurality of linear actuators 615A, 615B, 615C . . . 615N may move independently, allowing for numerous adjustments to the flexible PCB substrate 605.

FIG. 6C shows a work surface where the plurality of linear actuators 615A, 615B, 615C . . . 615N have adjusted the flexible PCB substrate 605. In operation, each linear actuator of the plurality of linear actuators 615A, 615B, 615C . . . 615N moves independently to bend, curve, and otherwise manipulate the flexible PCB substrate 605.

In operation, as shown in FIG. 6D, one or more micro-robots 200A, 200B may levitate (such as shown in FIG. 2B) over the flexible PCB substrate 605. In some embodiments, the flexible PCB substrate 605 is adjusted before the one or more micro-robots 200A, 200B move over it. In other embodiments, the flexible PCB substrate 605 may be adjusted dynamically, that is, while the one or more micro-robots 200A, 200B are in motion. While the one or more micro-robots 200A, 200B are illustrated as squares for simplicity, it should be understood that the one or more micro-robots may be any of the micro-robots or micro-robot platforms shown and described herein. In some embodiments, the flexible PCB substrate 605 is configured to adjust a pitch, a yaw, a roll, or a combination thereof of the one or more microrobots 200A, 200B.

While illustrative embodiments have been illustrated and described, it will be appreciated that various changes can be made therein without departing from the spirit and scope of the invention.

The present application may reference quantities and numbers. Unless specifically stated, such quantities and numbers are not to be considered restrictive, but representative of the possible quantities or numbers associated with the present application. Also, in this regard, the present application may use the term “plurality” to reference a quantity or number. In this regard, the term “plurality” is meant to be any number that is more than one, for example, two, three, four, five, etc. The terms “about,” “approximately,” “near,” etc., mean plus or minus 5% of the stated value. For the purposes of the present disclosure, the phrase “at least one of A, B, and C,” for example, means (A), (B), (C), (A and B), (A and C), (B and C), or (A, B, and C), including all further possible permutations when greater than three elements are listed.

Embodiments disclosed herein may utilize circuitry in order to implement technologies and methodologies described herein, operatively connect two or more components, generate information, determine operation conditions, control an appliance, device, or method, and/or the like. Circuitry of any type can be used. In an embodiment, circuitry includes, among other things, one or more computing devices such as a processor (e.g., a microprocessor), a central processing unit (CPU), a digital signal processor (DSP), an application-specific integrated circuit (ASIC), a field-programmable gate array (FPGA), or the like, or any combinations thereof, and can include discrete digital or analog circuit elements or electronics, or combinations thereof.

An embodiment includes one or more data stores that, for example, store instructions or data. Non-limiting examples of one or more data stores include volatile memory (e.g., Random Access memory (RAM), Dynamic Random Access memory (DRAM), or the like), non-volatile memory (e.g., Read-Only memory (ROM), Electrically Erasable Programmable Read-Only memory (EEPROM), Compact Disc Read-Only memory (CD-ROM), or the like), persistent memory, or the like. Further non-limiting examples of one or more data stores include Erasable Programmable Read-Only memory (EPROM), flash memory, or the like. The one or more data stores can be connected to, for example, one or more computing devices by one or more instructions, data, or power buses.

In an embodiment, circuitry includes a computer-readable media drive or memory slot configured to accept signal-bearing medium (e.g., computer-readable memory media, computer-readable recording media, or the like). In an embodiment, a program for causing a system to execute any of the disclosed methods can be stored on, for example, a computer-readable recording medium (CRMM), a signal-bearing medium, or the like. Non-limiting examples of signal-bearing media include a recordable type medium such as any form of flash memory, magnetic tape, floppy disk, a hard disk drive, a Compact Disc (CD), a Digital Video Disk (DVD), Blu-Ray Disc, a digital tape, a computer memory, or the like, as well as transmission type medium such as a digital and/or an analog communication medium (e.g., a fiber optic cable, a waveguide, a wired communications link, a wireless communication link (e.g., transmitter, receiver, transceiver, transmission logic, reception logic, etc.). Further non-limiting examples of signal-bearing media include, but are not limited to, DVD-ROM, DVD-RAM, DVD+RW, DVD-RW, DVD-R, DVD+R, CD-ROM, Super Audio CD, CD-R, CD+R, CD+RW, CD-RW, Video Compact Discs, Super Video Discs, flash memory, magnetic tape, magneto-optic disk, MINIDISC, non-volatile memory card, EEPROM, optical disk, optical storage, RAM, ROM, system memory, web server, or the like.

The detailed description set forth above in connection with the appended drawings, where like numerals reference like elements, are intended as a description of various embodiments of the present disclosure and are not intended to represent the only embodiments. Each embodiment described in this disclosure is provided merely as an example or illustration and should not be construed as preferred or advantageous over other embodiments. The illustrative examples provided herein are not intended to be exhaustive or to limit the disclosure to the precise forms disclosed. Similarly, any steps described herein may be interchangeable with other steps, or combinations of steps, in order to achieve the same or substantially similar result. Generally, the embodiments disclosed herein are non-limiting, and the inventors contemplate that other embodiments within the scope of this disclosure may include structures and functionalities from more than one specific embodiment shown in the figures and described in the specification.

In the foregoing description, specific details are set forth to provide a thorough understanding of exemplary embodiments of the present disclosure. It will be apparent to one skilled in the art, however, that the embodiments disclosed herein may be practiced without embodying all the specific details. In some instances, well-known process steps have not been described in detail in order not to unnecessarily obscure various aspects of the present disclosure. Further, it will be appreciated that embodiments of the present disclosure may employ any combination of features described herein.

The present application may include references to directions, such as “vertical,” “horizontal,” “front,” “rear,” “left,” “right,” “top,” and “bottom,” etc. These references, and other similar references in the present application, are intended to assist in helping describe and understand the particular embodiment (such as when the embodiment is positioned for use) and are not intended to limit the present disclosure to these directions or locations.

The present application may also reference quantities and numbers. Unless specifically stated, such quantities and numbers are not to be considered restrictive, but exemplary of the possible quantities or numbers associated with the present application. Also, in this regard, the present application may use the term “plurality” to reference a quantity or number. In this regard, the term “plurality” is meant to be any number that is more than one, for example, two, three, four, five, etc. The term “about,” “approximately,” etc., means plus or minus 5% of the stated value. The term “based upon” means “based at least partially upon.”

The principles, representative embodiments, and modes of operation of the present disclosure have been described in the foregoing description. However, aspects of the present disclosure, which are intended to be protected, are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure as claimed.

We claim:

1. A system for wirelessly powering a micro-robot platform, the system comprising:
a micro-robot platform, comprising:
a micro-robot having a plurality of magnets;
a plurality of printed circuit board (PCB) layers arranged in a stack-up structure;
a magnetic levitation (MAGLEV) stack, comprising:
a micro-robot driver circuit configured to levitate the micro-robot platform;
a wireless power stack, comprising:
a power storage device;
a first inductive loop coil configured to charge the power storage device; and
a wireless power driver circuit;
a microcontroller unit (MCU); and
one or more of wireless charging zones, comprising:
a second inductive loop coil magnetically coupled to the first inductive loop coil, wherein the second inductive loop coil is configured to transfer power to the first inductive loop coil; and
wherein the micro-robot platform is configured to levitate over the one or more wireless charging zones.

2. The system of claim 1,
wherein the MCU includes a demultiplexer; and
wherein the demultiplexer is configured to receive a direct current and provide power to the MAGLEV stack and the wireless power stack.

3. The system of claim 2, wherein the demultiplexer alternates between charging the power storage device for a first duration of time and powering the MAGLEV stack for a second duration of time.

4. The system of claim 2, further comprising:
a peripheral stack, wherein the demultiplexer is configured to receive a direct current and provide power for the peripheral stack.

5. The system of claim 1, wherein the first inductive loop coil is a PCB coil.

6. The system of claim 1, wherein the first inductive loop coil is electrically coupled to the power storage device and secured to the micro-robot platform with an adhesive.

7. The system of claim 1, further comprising:
a work surface, comprising:
a flexible PCB substrate;
a motor base located under the flexible PCB substrate; and
one or more linear actuators coupled to the motor base, wherein the one or more linear actuators are configured to adjust the flexible PCB substrate;
wherein the flexible PCB substrate is configured to adjust a pitch, a yaw, a roll, or a combination thereof of the micro-robot platform; and
wherein the micro-robot platform is configured to levitate over the work surface.

8. The system of claim 7, wherein the one or more of wireless charging zones is disposed within the work surface.

9. The system of claim 7, wherein the one or more of wireless charging zones is disposed a distance away from the work surface.

10. The system of claim 1, wherein the power storage device is a battery.

11. The system of claim 1, wherein the power storage device is a supercapacitor.

12. The system of claim 1, wherein the first inductive loop coil and the second inductive loop coil are magnetically coupled by a Qi interface standard.

13. A method for providing wireless power to a levitating micro-robot platform, the method comprising:
magnetically coupling a first inductive loop coil with a second inductive loop coil;
securing the first inductive loop coil to a micro-robot platform, wherein the first inductive loop coil is electrically coupled with a power storage device;
positioning the micro-robot platform above the second inductive loop coil;
generating a magnetic field between the first inductive loop coil and the second inductive loop coil, wherein the magnetic field generates an alternating current in the first inductive loop coil;
converting the alternating current into a direct current; and
charging the power storage device;
wherein the micro-robot platform is arranged in a stack-up structure, and wherein the micro-robot platform is configured to levitate above the second inductive loop coil.

14. The method of claim 13, further comprising:
receiving, at a demultiplexer the direct current; and
providing power to a magnetic levitation (MAGLEV) stack and a wireless power stack, wherein the demultiplexer alternates between charging the power storage device for a first duration of time and powering the MAGLEV stack for a second duration of time.

15. The method of claim 14, wherein the demultiplexer is configured to receive a direct current and provide power for a peripheral stack.

16. The method of claim 13, wherein the first inductive loop coil is a PCB coil.

17. The method of claim 13, wherein the first inductive coil is electrically coupled to the power storage device and secured to the micro-robot platform with an adhesive.

18. The method of claim 13, wherein the power storage device is a battery.

19. The method of claim 13, wherein the power storage device is a supercapacitor.

20. The method of claim 13, wherein the first inductive loop coil and the second inductive loop coil are magnetically coupled by a Qi interface standard.
